(19) United States
(12) Patent Application Publication
(10) Pub. No.: US 2012/0257344 A1
(43) Pub. Date: Oct. 11, 2012

(54) PORTABLE KEYBOARD

(76) Inventors: Chia-Hung Liu, Taoyuan (TW); Ting-Kuei Cheng, Taoyuan (TW); Chang-En Sun, Taoyuan (TW)

(21) Appl. No.: 13/239,346

(22) Filed: Sep. 21, 2011

(30) Foreign Application Priority Data
Apr. 6, 2011 (TW) 100206006

(51) Int. Cl. G06F 1/16

(52) U.S. Cl. 361/679.15; 361/679.2

(57) ABSTRACT

A portable keyboard includes a base, a casing pivotally connected to the base, and a foldable keyboard. The foldable keyboard is disposed on the base and includes a first keyboard module, a second keyboard module and a pivot. The first keyboard module is pivotally connected to the second keyboard module by the pivot, such that the first keyboard module and the second keyboard module can be folded or expanded with respect to each other over the base. When the first and second keyboard modules are folded with respect to each other over the base, the foldable keyboard can be accommodated in the casing. When the casing rotates with respect to the base such that an angle is formed therebetween, the first and second keyboard modules can be expanded with respect to each other over the base.

### BACKGROUND OF THE INVENTION

1. Field of the Invention

The invention relates to a portable keyboard and, more particularly, to a portable keyboard equipped with a foldable keyboard.

2. Description of the Prior Art

As technology advances and develops, various electronic devices, such as mobile phone, personal digital assistant, tablet personal computer, electronic paper, and so on, have been used in daily life widely. Since the size of the aforesaid electronic device is usually small, a connecting port is disposed on the electronic device and used for connecting a keyboard for input purpose. If a user wants to use the electronic device for a long time, the user is used to place the electronic device on a support frame, such that an appropriate operation angle is formed between the electronic device and the user. Accordingly, the user can use the external keyboard to operate the electronic device for a long time comfortably. However, in the prior art, since the keyboard and the support frame are independent, the user needs to store the keyboard and the support frame in additional space respectively. Consequently, the keyboard and the support frame are easy to be lost.

### SUMMARY OF THE INVENTION

Therefore, an objective of the invention is to provide a portable keyboard equipped with a foldable keyboard so as to solve the aforesaid problems.

According to an embodiment, a portable keyboard comprises a base, a casing and a foldable keyboard. The casing is pivotally connected to the base. The foldable keyboard is disposed on the base. The foldable keyboard comprises a first keyboard module, a second keyboard module and a pivot. The first keyboard module is pivotally connected to the second keyboard module by the pivot, such that the first keyboard module and the second keyboard module can be folded or expanded with respect to each other over the base. When the first and second keyboard modules are folded with respect to each other over the base, the foldable keyboard can be accommodated in the casing. When the casing rotates with respect to the base such that an angle is formed therebetween, the first and second keyboard modules can be expanded with respect to each other over the base.

As mentioned in the above, since the first and second keyboard modules of the foldable keyboard are pivotally connected to each other by the pivot, the first and second keyboard modules can rotate with respect to each other over the base so as to be folded or expanded over the base. When a user wants store or carry the portable keyboard, the user has to rotate the first and second keyboard modules so as to fold the first and second keyboard modules over the base and then closes the casing on the base, such that the foldable keyboard is accommodated in the casing. On the other hand, when the user wants to use the foldable keyboard to operate an electronic device disposed on the casing, the user has to open the casing away from the base and then rotates the first and second keyboard modules so as to expand the first and second keyboard modules over the base, such that the user can use the first and second keyboard modules to operate the electronic device disposed on the casing conveniently.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a portable keyboard according to an embodiment of the invention.

FIG. 2 is an exploded view illustrating the portable keyboard shown in FIG. 1.

FIG. 3 is a perspective view illustrating the portable keyboard shown in FIG. 1 from another view angle.

FIG. 4 is an exploded view illustrating the portable keyboard shown in FIG. 3.

FIG. 5 is a perspective view illustrating the casing opened away from the base shown in FIG. 1.

FIG. 6 is a perspective view illustrating the foldable keyboard shown in FIG. 5 being expanded.

FIG. 7 is a perspective view illustrating the portable keyboard shown in FIG. 6 from another view angle.

FIG. 8 is a perspective view illustrating the foldable keyboard shown in FIG. 5 expanded over the base completely.

FIG. 9 is a perspective view illustrating the portable keyboard shown in FIG. 8 from another view angle.

FIG. 10 is a perspective view illustrating the portable keyboard supported by the support member on a plane.

FIG. 11 is a perspective view illustrating the inner holder shown in FIG. 8 rotating with respect to the outer holder.

FIG. 12 is a perspective view illustrating the electronic device exposed out of the portable keyboard.

FIG. 13 is a perspective view illustrating a portable keyboard according to another embodiment of the invention.

FIG. 14 is a perspective view illustrating a portable keyboard according to another embodiment of the invention.

### DETAILED DESCRIPTION

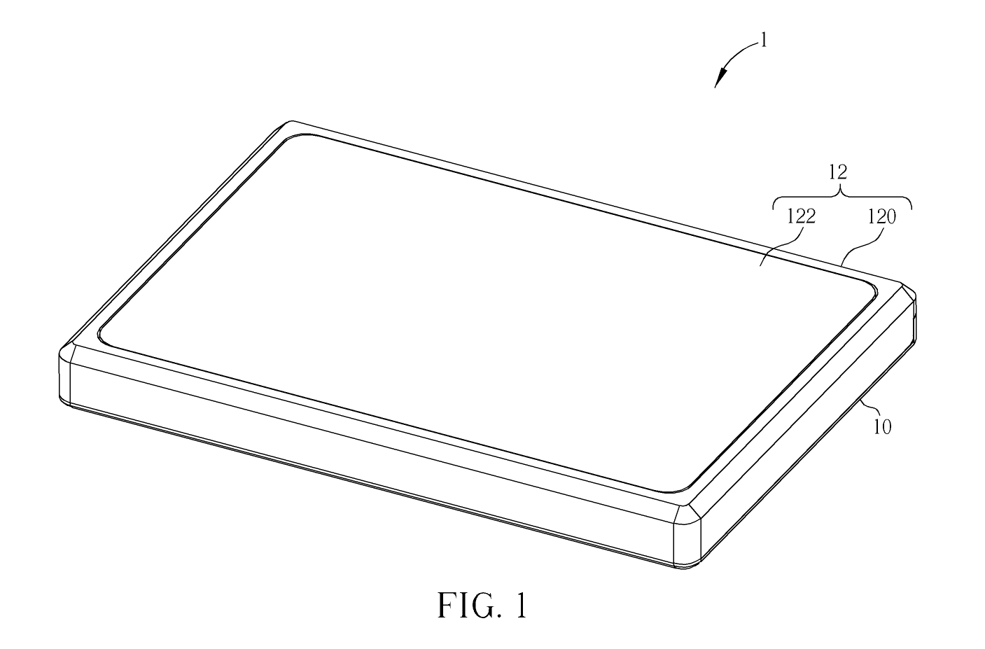

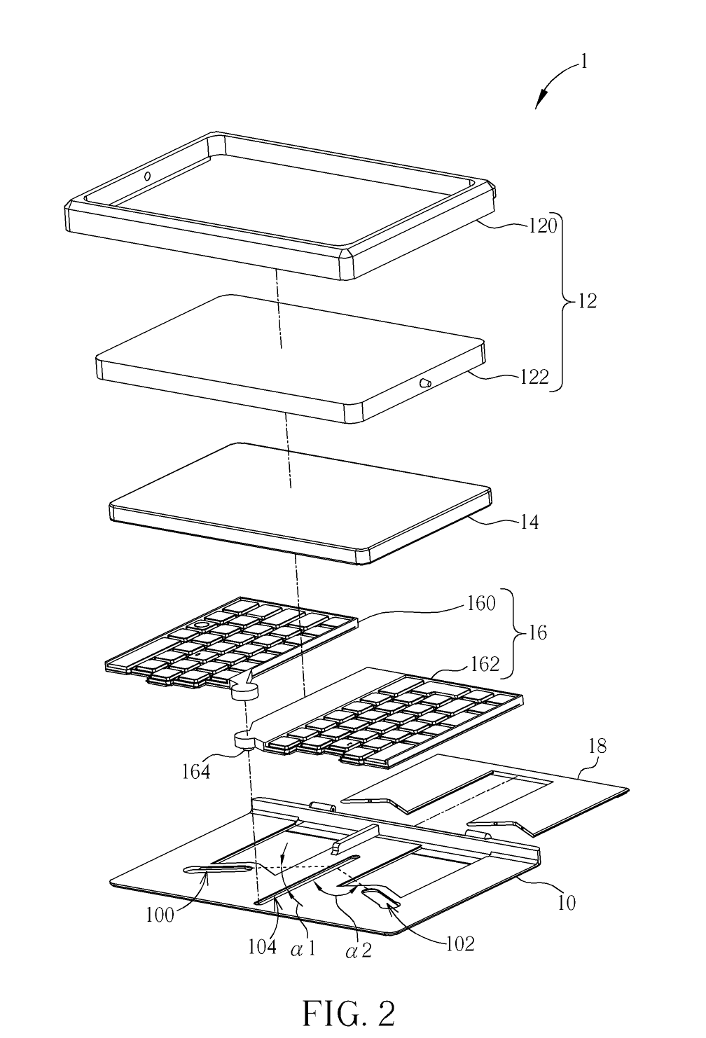

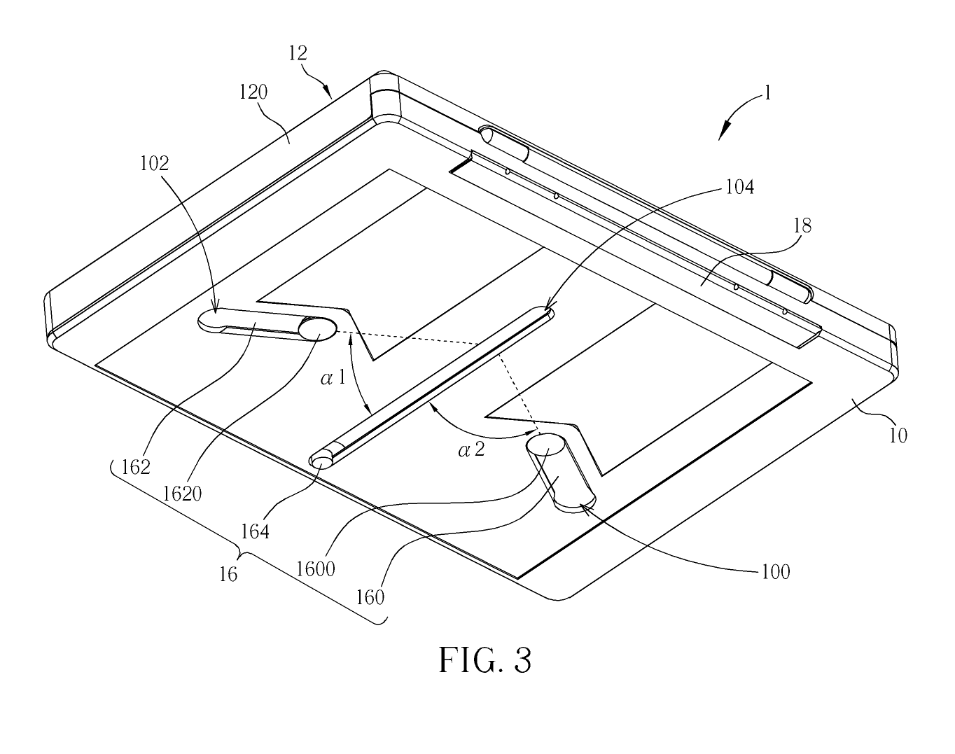

Referring to FIGS. 1 to 4, FIG. 1 is a perspective view illustrating a portable keyboard 1 according to an embodiment of the invention, FIG. 2 is an exploded view illustrating the portable keyboard 1 shown in FIG. 1, FIG. 3 is a perspective view illustrating the portable keyboard 1 shown in FIG. 1 from another view angle, and

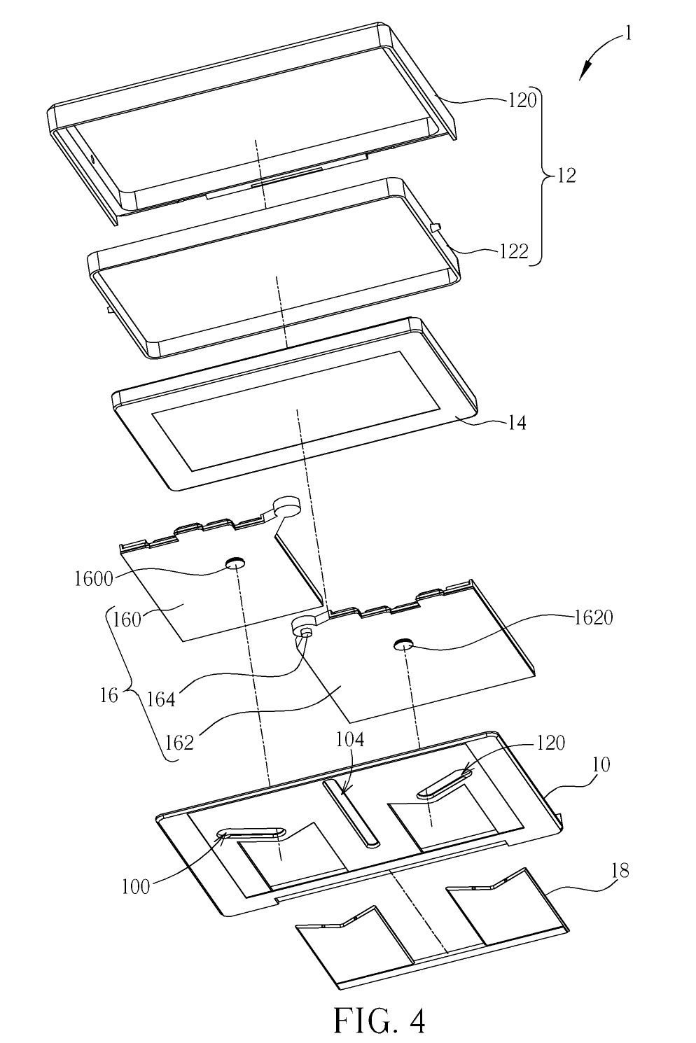

FIG. 4 is an exploded view illustrating the portable keyboard 1 shown in FIG. 3.

As shown in FIGS. 1 to 4, the portable keyboard 1 comprises a base 10, a casing 12, a foldable keyboard 16 and a support member 18. The casing 12 is pivotally connected to the base 10. An electronic device 14 can be detachably disposed on the casing 12. In this embodiment, a user may install the electronic device 14 on the casing 12 so as to use the foldable keyboard 16 to operate the electronic device 14 or, alternatively, the user may detach the electronic device 14 from the casing 12 so as to use the electronic device 14 independently. In this embodiment, the casing 12 may comprise an outer holder 120 and an inner holder 122. The outer holder 120 is pivotally connected to the base 10 and the inner holder 122 is pivotally connected within the outer holder 120. The electronic device 14 may be detachably disposed on the inner holder 122. In practical applications, the electronic device 14 may be a tablet personal computer or other portable electronic devices.

The foldable keyboard 16 is disposed on the base 10. In this embodiment, the foldable keyboard 16 comprises a first keyboard module 160, a second keyboard module 162 and a pivot 164, wherein the bottom of the first keyboard module 160 may have a first protrusion 1600 and the bottom of the second keyboard module 162 may have a second protrusion 1620. Furthermore, the base may 10 have a first slot 100, a second slot 102 opposite to the first slot 100, and a third slot 104 located between the first slot 100 and the second slot 102, wherein an angle α1 between an orientation of the first slot 100 and an orientation of the third slot 104 is equal to an angle α2 between an orientation of the second slot 102 and the orientation of the third slot 104. In this embodiment, the angles α1 and α2 are acute angles. However, in another embodiment, the angles α1 and α2 may be right angles or obtuse angles and the angle α1 may be unequal to the angle α2. In other words, the angles α1 and α2 may be determined based on practical applications.

In this embodiment, the first protrusion 1600 of the first keyboard module 160 is disposed in the first slot 100 of the base 10, the second protrusion 1620 of the second keyboard module 162 is disposed in the second slot 102 of the base 10, the first keyboard module 160 is pivotally connected to the second keyboard module 162 by the pivot 164, and one end of the pivot 164 is movably disposed in the third slot 104 of the base 10. Accordingly, when the first keyboard module 160 and the second keyboard module 162 rotate with respect to each other, the first protrusion 1600 and the second protrusion 1620 can rotate and move within the first slot 100 and the second slot 102 respectively and the pivot 164, which pivotally connects the first keyboard module 160 and the second keyboard module 162, can move within the third slot 104, such that the first keyboard module 160 and the second keyboard module 162 can be folded or expanded with respect to each other over the base 10.

It should be noted that the assembly structures of the foldable keyboard 16 and the base are not limited to the aforesaid embodiment. In other words, the main feature of the invention is that the first keyboard module 160 and the second keyboard module 162 of the foldable keyboard 16 can rotate with respect to each other so as to be folded or expanded over the base 10.

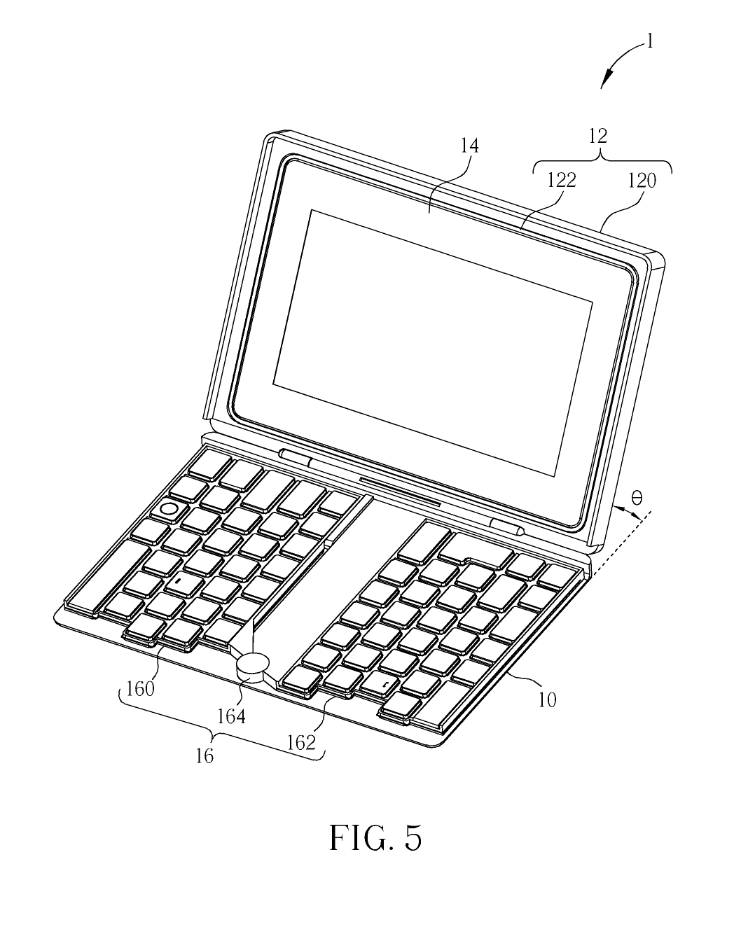

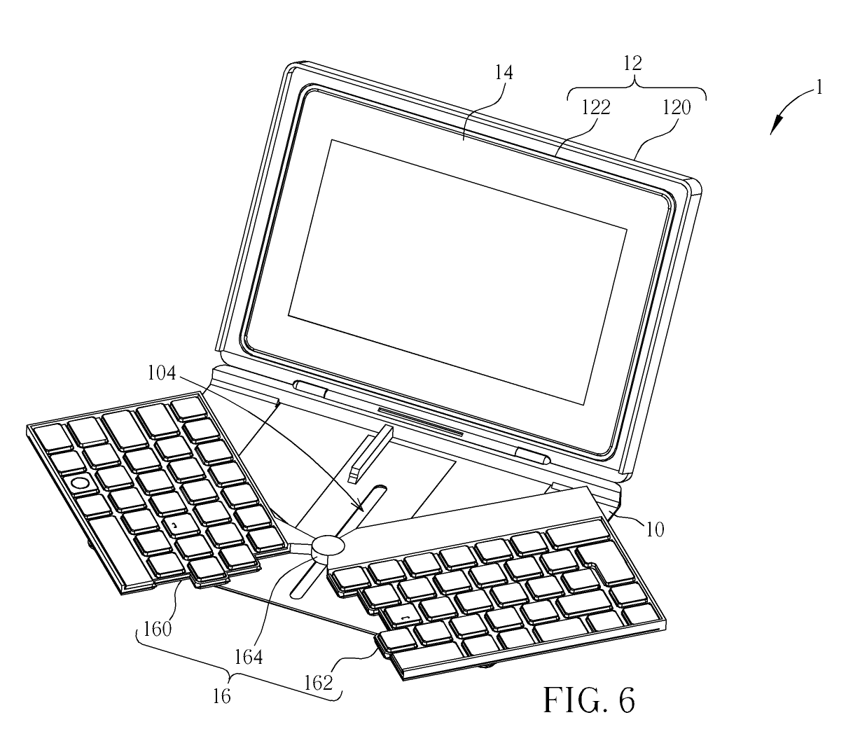

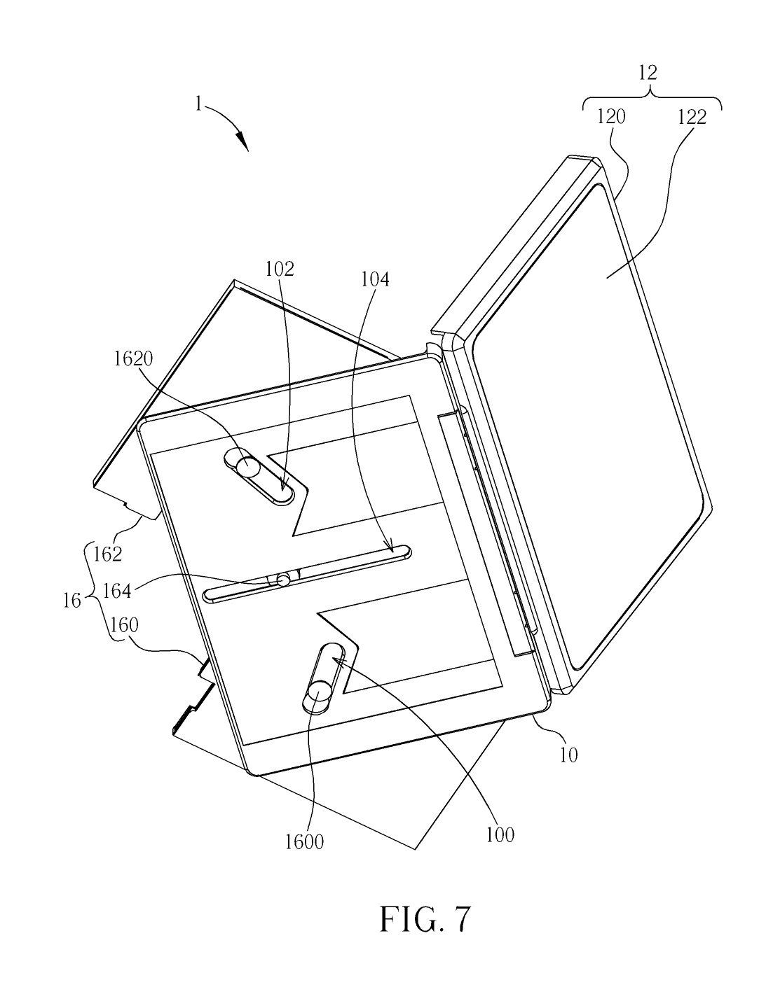

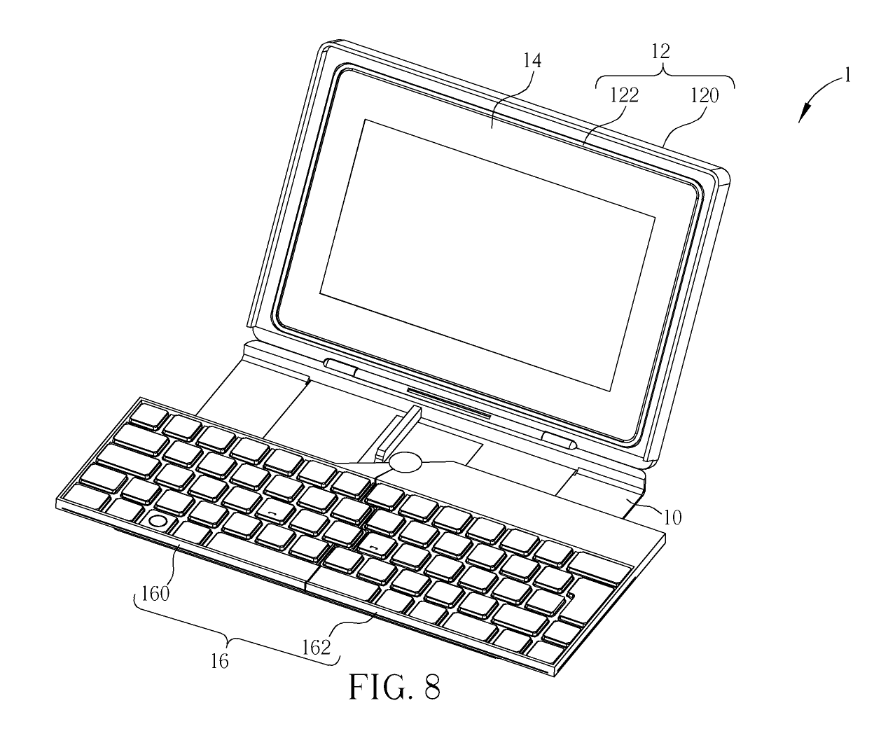

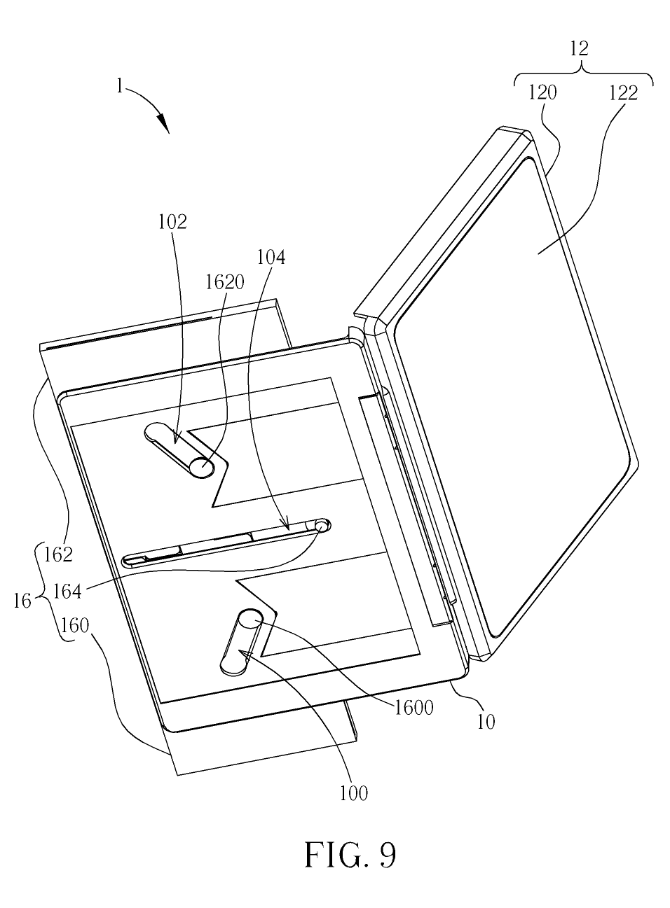

Referring to FIGS. 5 to 9, FIG. 5 is a perspective view illustrating the casing 12 opened away from the base 10 shown in FIG. 1, FIG. 6 is a perspective view illustrating the foldable keyboard 16 shown in FIG. 5 being expanded, FIG. 7 is a perspective view illustrating the portable keyboard 1 shown in FIG. 6 from another view angle, FIG. 8 is a perspective view illustrating the foldable keyboard 16 shown in FIG. 5 expanded over the base 10 completely, and FIG. 9 is a perspective view illustrating the portable keyboard 1 shown in FIG. 8 from another view angle.

When a user wants to use the portable keyboard 1 to operate the electronic device 14, the user has to rotate the casing 12 with respect to the base 10 such that an angle θ is formed therebetween, as shown in FIG. 5. Afterward, the user has to rotate the first keyboard module 160 and the second keyboard module 162 of the foldable keyboard 16 with respect to each other so as to be expanded over the base 10 completely, as shown in FIGS. 6 to 9. At this time, the user can use the foldable keyboard 16 to operate the electronic device 14 disposed on the casing 12. When the user finishes using the portable keyboard 1 to operate the electronic device 14, the user has to rotate the first keyboard module 160 and the second keyboard module 162 of the foldable keyboard 16 with respect to each other so as to be folded over the base 10. Afterward, the user has to close the casing 12 on the base 10 so as to store the foldable keyboard 16 in the casing 12. At this time, the electronic device 14 is hidden in the casing 12 so as to prevent the electronic device 14 from being scratched or damaged. In this embodiment, the electronic device 14 may communicate with the first keyboard module 160 and the second keyboard module 162 of the foldable keyboard 16 in wireless (e.g. wireless transmitting technology including Bluetooth, WiFi, infra red, etc.).

In this embodiment, the invention may utilize hinge assembly (not shown), which can provide torque, to pivotally connect the aforesaid casing 12 and base 10. Since the hinge assembly can provide torque for keeping a rotating angle between the casing 12 and the base 10, the user can adjust the electronic device 14 disposed on the casing 12 to a comfortable view angle. It should be noted that the hinge assembly is well known by one skilled in the art and it will not be depicted herein.

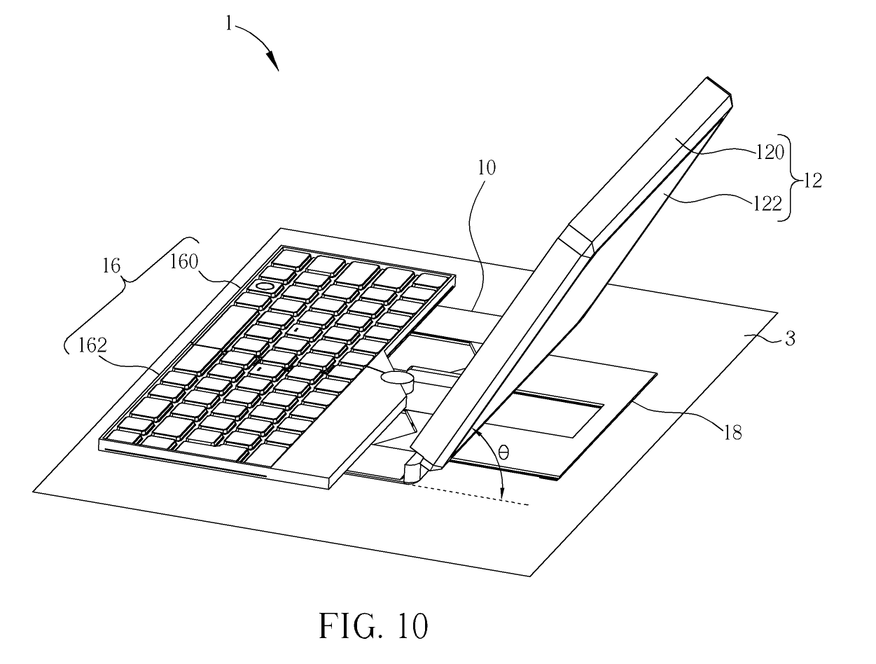

Referring to FIG. 10, FIG. 10 is a perspective view illustrating the portable keyboard 1 supported by the support member 18 on a plane 3. In this embodiment, the support member 18 is slidably disposed on a bottom of the base 10. When the casing 12 rotates with respect to the base 10 such that the angle θ is formed therebetween and the support member 18 slides with respect to the base 10 to the expanded position shown in FIG. 10, the support member 18 can support the portable keyboard 1 on the plane 3. Accordingly, when the user operates the foldable keyboard 16, the portable keyboard 1 can be placed on the plane 3 more stably.

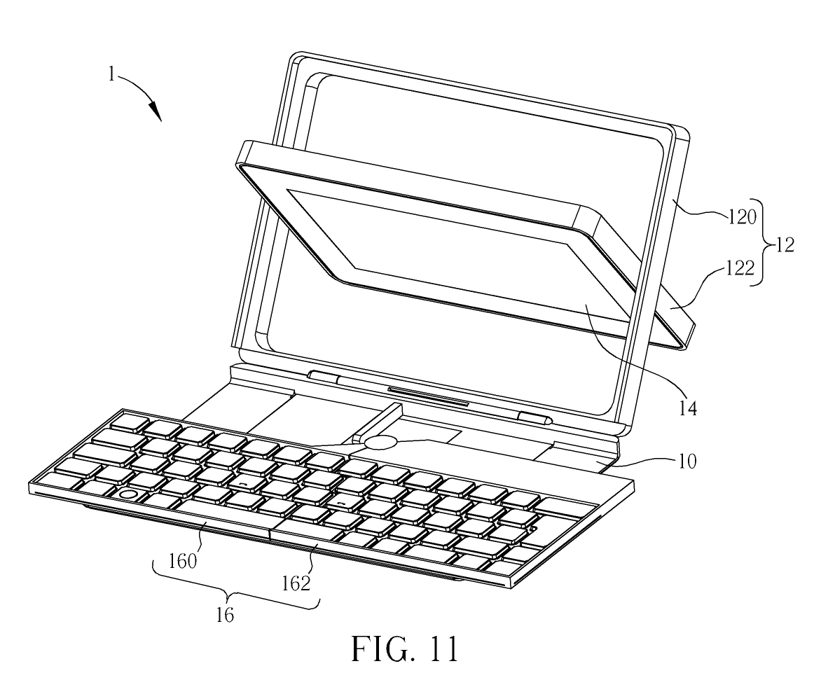

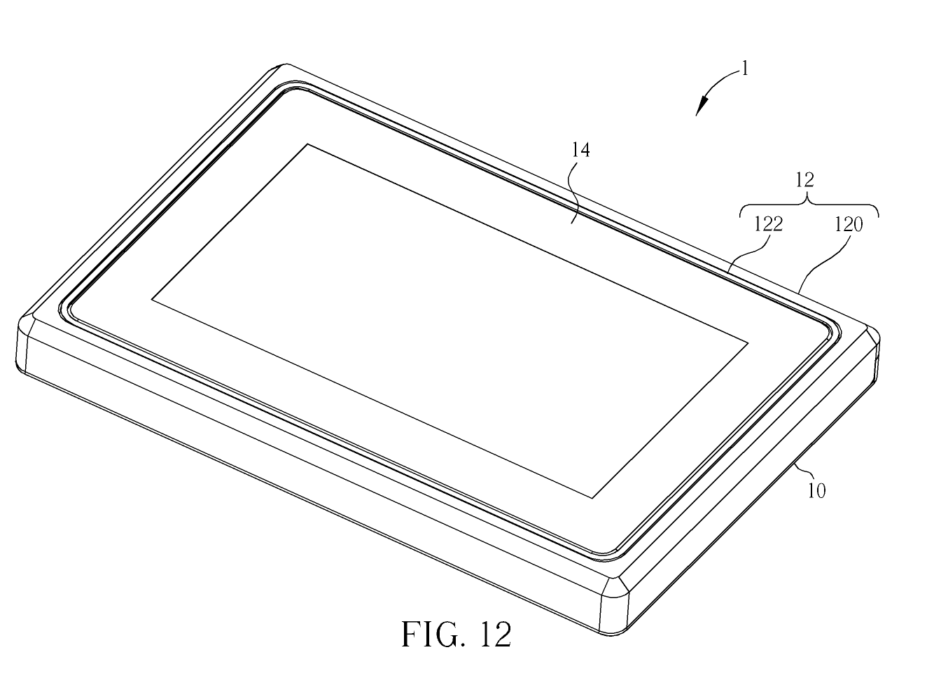

Referring to FIGS. 11 and 12, FIG. 11 is a perspective view illustrating the inner holder 122 shown in FIG. 8 rotating with respect to the outer holder 120, and FIG. 12 is a perspective view illustrating the electronic device 14 exposed out of the portable keyboard 1. As shown in FIG. 11, the user can rotate the inner holder 122 with respect to the outer holder 120. Afterward, the user can rotate the first keyboard module 160 and the second keyboard module 162 of the foldable keyboard 16 with respect to each other so as to be folded over the base 10 and close the casing 12 on the base 10. Consequently, the foldable keyboard 16 is accommodated in the casing 12 and the electronic device 14 is exposed out of the portable keyboard 1. At this time, the user can operate the electronic device 14 directly. When the user finishes using the electronic device 14, the user can open the casing 12 away from the base 10, rotate the inner holder 122 with respect to the outer holder 120, and close the casing 12 on the base 10, such that the electronic device 14 is hidden in the casing 12.

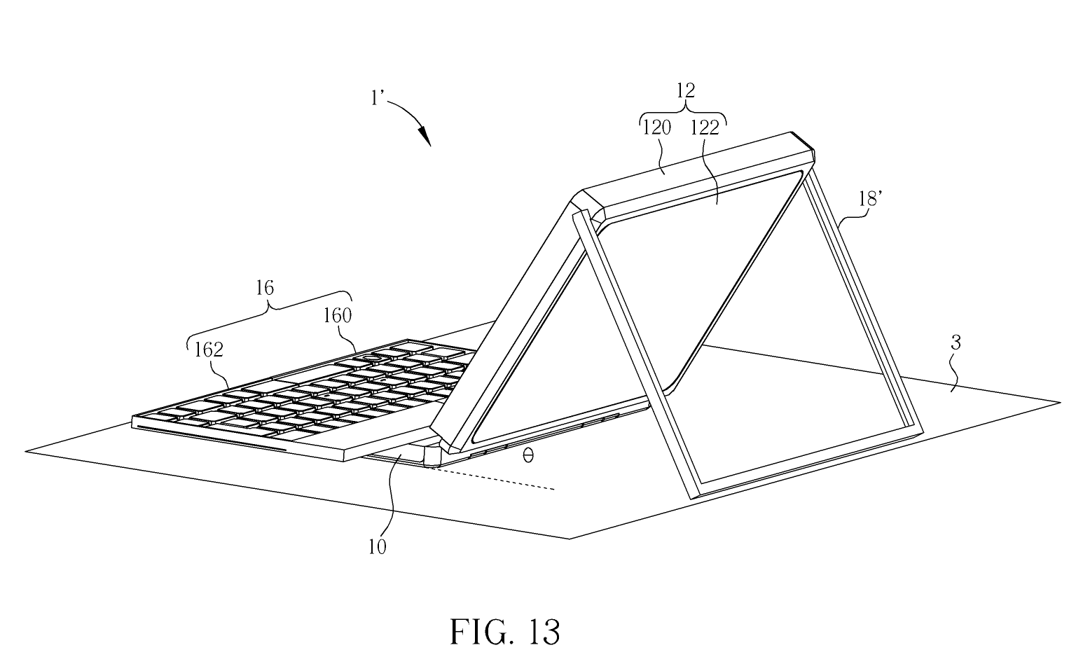

Referring to FIG. 13, FIG. 13 is a perspective view illustrating a portable keyboard 1′ according to another embodiment of the invention. The main difference between the portable keyboard 1′ and the aforesaid portable keyboard 1 is that both ends of the support member 18′ of the portable keyboard 1′ are pivotally connected to both sides of the outer holder 120 of the casing 12. When the casing 12 rotates with respect to the base 10 such that the angle θ is formed therebetween and the support member 18′ rotates with respect to the casing 12 to the expanded position shown in FIG. 13, the support member 18′ can support the portable keyboard 1′ on the plane 3. Accordingly, when the user operates the foldable keyboard 16, the portable keyboard 1′ can be placed on the plane 3 more stably. It should be noted that the same elements in FIGS. 13 and 10 are represented by the same numerals, so the repeated explanation will not be depicted herein.

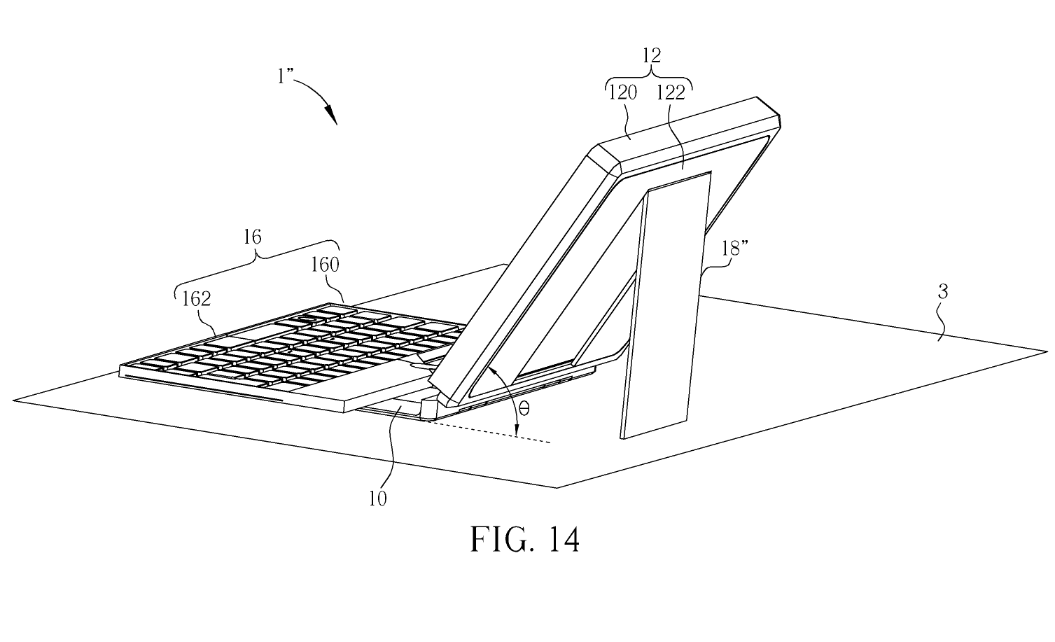

Referring to FIG. 14, FIG. 14 is a perspective view illustrating a portable keyboard 1″ according to another embodiment of the invention. The main difference between the portable keyboard 1″ and the aforesaid portable keyboard 1 is that one end of the support member 18″ of the portable keyboard 1″ is pivotally connected to the back of the inner holder 122 of the casing 12. When the casing 12 rotates with respect to the base 10 such that the angle θ is formed therebetween and the support member 18″ rotates with respect to the casing 12 to the expanded position shown in FIG. 14, the support member 18″ can support the portable keyboard 1″ on the plane 3. Accordingly, when the user operates the foldable keyboard 16, the portable keyboard 1″ can be placed on the plane 3 more stably. It should be noted that the same elements in FIGS. 14 and 10 are represented by the same numerals, so the repeated explanation will not be depicted herein.

As mentioned in the above, since the first and second keyboard modules of the foldable keyboard are pivotally connected to each other by the pivot, the first and second keyboard modules can rotate with respect to each other over the base so as to be folded or expanded over the base. When a user wants store or carry the portable keyboard, the user has to rotate the first and second keyboard modules so as to fold the first and second keyboard modules over the base and then closes the casing on the base, such that the foldable keyboard is accommodated in the casing. On the other hand, when the user wants to use the foldable keyboard to operate the electronic device disposed on the casing, the user has to open the casing away from the base and then rotates the first and second keyboard modules so as to expand the first and second keyboard modules over the base, such that the user can use the first and second keyboard modules to operate the electronic device disposed on the casing conveniently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable keyboard comprising:
a base;
a casing pivotally connected to the base; and
a foldable keyboard disposed on the base, the foldable keyboard comprising a first keyboard module, a second keyboard module and a pivot, the first keyboard module being pivotally connected to the second keyboard module by the pivot, such that the first keyboard module and the second keyboard module are capable of being folded or expanded with respect to each other over the base;
wherein when the first and second keyboard modules are folded with respect to each other over the base, the foldable keyboard is capable of being accommodated in the casing; when the casing rotates with respect to the base such that an angle is formed therebetween, the first and second keyboard modules are capable of being expanded with respect to each other over the base.

2. The portable keyboard of claim 1, wherein the casing comprises an outer holder and an inner holder, the outer holder is pivotally connected to the base, the inner holder is pivotally connected within the outer holder.

3. The portable keyboard of claim 1, further comprising a support member slidably disposed on a bottom of the base, wherein when the casing rotates with respect to the base such that the angle is formed therebetween and the support member slides with respect to the base to an expanded position, the support member is capable of supporting the portable keyboard on a plane.

4. The portable keyboard of claim 1, further comprising a support member, one end of the support member being pivotally connected a back of the casing, wherein when the casing rotates with respect to the base such that the angle is formed therebetween and the support member rotates with respect to the casing to an expanded position, the support member is capable of supporting the portable keyboard on a plane.

5. The portable keyboard of claim 1, further comprising a support member, both ends of the support member being pivotally connected both sides of the casing respectively, wherein when the casing rotates with respect to the base such that the angle is formed therebetween and the support member rotates with respect to the casing to an expanded position, the support member is capable of supporting the portable keyboard on a plane.

6. The portable keyboard of claim 1, wherein the base has a first slot and a second slot opposite to the first slot, the first keyboard module has a first protrusion disposed in the first slot, the second keyboard module has a second protrusion disposed in the second slot, when the first and second keyboard modules rotate with respect to each other, the first and second protrusions rotates and moves within the first and second slots respectively such that the first and second keyboard modules are folded or expanded with respect to each other over the base.

7. The portable keyboard of claim 6, wherein the base further has a third slot located between the first and second slots and one end of the pivot is movably disposed in the third slot.

8. The portable keyboard of claim 7, wherein an angle between an orientation of the first slot and an orientation of the third slot is equal to an angle between an orientation of the second slot and the orientation of the third slot.

9. The portable keyboard of claim 1, wherein an electronic device is detachably disposed on the casing and the electronic device is a tablet personal computer.

10. The portable keyboard of claim 9, wherein the electronic device communicates with the foldable keyboard in wireless.
